(19) United States
(12) Patent Application Publication
(10) Pub. No.: US 2024/0051258 A1
(43) Pub. Date: Feb. 15, 2024

(54) FIRE-RESISTANT COMPOSITE SHEET

(71) Applicant: DUPONT SAFETY & CONSTRUCTION, INC., Wilimington, DE (US)

(72) Inventor: Dariusz W. Kawka, Midlothian, VA (US)

(73) Assignee: DUPONT SAFETY & CONSTRUCTION, INC., Wilimington, DE (US)

(21) Appl. No.: 17/884,500

(22) Filed: Aug. 9, 2022

(51) Int. Cl. B32B 5/08; B32B 5/02; B32B 7/08; B32B 27/08; B32B 27/12

(52) U.S. Cl. CPC B32B 5/08; B32B 5/022; B32B 5/024; B32B 7/08; B32B 27/08; B32B 27/12; B32B 2250/02; B32B 2250/24; B32B 2255/02; B32B 2255/26; B32B 2260/046; B32B 2260/021; B32B 2307/72; B32B 2307/718; B32B 2307/3065; B32B 2605/18

(57) ABSTRACT

A composite sheet comprises a textile component having a first surface and a second surface and a first polymeric coating on the first surface of the textile component wherein the textile component further comprises at least one woven fabric of continuous filament yarns, the fabric having an areal weight of from about 70 to about 508 gsm, and a nonwoven fabric comprising a blend of discontinuous fibers of oxidized polyacrylonitrile fibers and silica fibers wherein the oxidized polyacrylonitrile fibers are present in an amount of from about 30 to about 70 weight percent of the combined weight of the oxidized polyacrylonitrile fibers and silica fibers and, optionally, wherein the nonwoven fabric is mechanically attached to woven fabric.

### BACKGROUND OF THE INVENTION

### 1. Field of the Invention

Disclosed embodiments pertain generally to a composite sheet having fire-resistant properties. The sheet is useful as curtain walls for fire-resistant cargo containers, particularly containers used in aircraft.

### 2. Description of Related Art

The amount of freight carried in both passenger and cargo aircraft has been increasing for a number of years. Along with this, there have been increasing concerns for fire risks within cargo containers due to a rise in the amount of power sources, such as a high density energy storage devices or other battery types, in cargo. Five recent developments of fire-resistant composite sheets for cargo container walls are described below.

U.S. Pat. No. 9,296,555 to Kawka and Chang is directed to a non-rigid composite sheet comprising in order (i) a first component having an areal density of from 88 to 678 gsm comprising a first fabric of filamentary yarns having a tenacity of at least 11 g/dtex and a UV and weather impervious first polymeric layer, (ii) a second component having an areal density of from 30 to 237 gsm comprising a flame resistant substrate and an inorganic refractory layer and (iii) a third component having an areal density of from 88 to 678 gsm comprising a second fabric of filamentary yarns having a tenacity of at least 11 g/dtex and an impact and scratch resistant second polymeric layer, the second fabric of the third component being adjacent to the refractory layer of the second component.

U.S. Pat. No. 9,302,845 to Kawka and Chang discloses a non-rigid composite sheet comprising in order a first component having an areal density of from 102 to 678 gsm comprising a first fabric of filamentary yarns having a tenacity of at least 11 g/dtex and a UV and weather impervious first polymeric layer, a second component having an areal density of from 10 to 170 gsm comprising a flame resistant inorganic refractory layer adjacent to the at least one protective polymeric layer and a third component having an areal density of from 102 to 678 gsm comprising a second fabric of filamentary yarns having a tenacity of at least 11 g/dtex and an impact and scratch resistant second polymeric layer, the second fabric of the third component being adjacent to the refractory layer of the second component.

U.S. Pat. No. 10,457,013 to Kawka and Perez teaches a non-rigid composite sheet comprising in order (i) a first component having an areal weight of from 88 to 678 gsm comprising a first fabric of filamentary yarns having a tenacity of at least 11 g/dtex and a UV and weather impervious first polymeric layer, (ii) a second component having an areal weight of from 120 to 430 gsm comprising a flame resistant paper and (iii) a third component having an areal weight of from 88 to 678 gsm comprising a second fabric of filamentary yarns having a tenacity of at least 11 g/dtex and an impact and scratch resistant second polymeric layer, the second fabric of the third component being adjacent to the paper of the second component.

U.S. Pat. No. 9,993,989 to Kawka describes a non-rigid composite sheet comprising in order (i) a first component comprising a first fabric of continuous filament yarns having a tenacity of at least 11 g/dtex and a first polymeric layer, (ii) a second component comprising at least one second fabric of continuous filament glass yarns, the second fabric being adjacent to the first fabric of the first component and (iii) a third component comprising a second polymeric layer.

U.S. Pat. No. 10,300,677 to Kawka pertains to a non-rigid composite sheet comprising in order (i) a first component comprising at least one first fabric of continuous filament yarns having a tenacity of at least 11 g/dtex and a first polymeric layer, (ii) a second component comprising at least one second fabric of continuous filament glass yarns, the at least one second fabric being adjacent to the at least one first fabric of the first component and (iii) a third component comprising a second polymeric layer.

However, there remains a need and desire for further fire-resistant composite sheets for cargo container walls that will provide improved fire protection. Further weight reductions are also desirable.

### BRIEF SUMMARY OF THE INVENTION

In one aspect, the present disclosure provides a composite sheet 11 comprising a textile component 12 having a first surface 13 and a second surface 14 and a first polymeric coating 15 on the first surface 13 of the textile component 12. The textile component 12 further comprises
a fabric structure 16 of at least one woven fabric of continuous filament yarns, the fabric having an areal weight of from about 70 to about 508 gsm and
a fabric structure 17 of a nonwoven fabric comprising a blend of discontinuous oxidized polyacrylonitrile fibers and silica fibers, wherein the oxidized polyacrylonitrile fibers are present in an amount of from about 30 to about 70 weight percent of the combined weight of the oxidized polyacrylonitrile fibers and silica fibers.

### BRIEF DESCRIPTION OF THE DRAWINGS

FIG. 1 is an exploded end view of a composite sheet 11 according to an exemplary embodiment.

FIG. 2 is an end view of a textile component 12 showing stitching through fabric structures 16 and 17 of the textile component 12 according to an exemplary embodiment.

FIG. 3 is an end view of a textile component 12 showing filament entanglement between fabric structures 16 and 17 of the textile component 12 according to an exemplary embodiment.

### DETAILED DESCRIPTION OF THE INVENTION

In the following detailed description, reference is made to the accompanying drawings which form a part hereof, and which illustrate exemplary embodiments of the invention. These embodiments are described in sufficient detail to enable those of ordinary skill in the art to make and use them. It is also understood that structural, logical, or procedural changes may be made to the exemplary embodiments disclosed herein without departing from the spirit or scope of the invention.

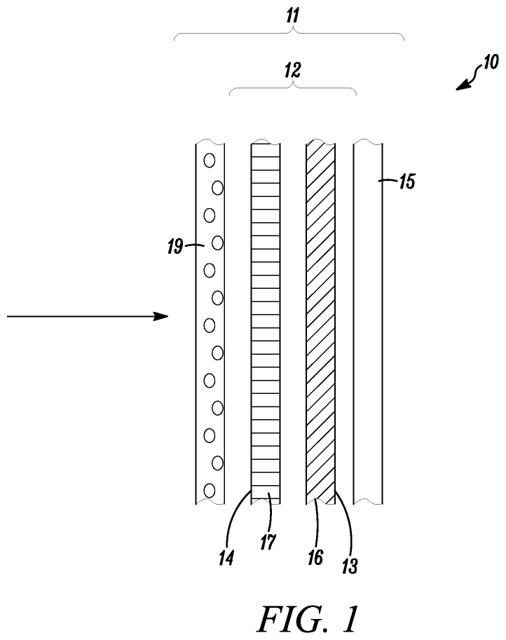

FIG. 1 shows generally at 10 an exemplary exploded end view of one embodiment of a composite fire-resistant sheet 11. The composite sheet 11 comprises a textile component 12 having a first surface 13 and a second surface 14 and a first polymeric coating 15 located on the first surface 13 of the textile component 12. An optional second polymeric coating 19 may be located on the second surface 14 of textile component 12.

### Textile Component

The textile component 12 comprises two different fabric structures.

Fabric structure 16 comprises at least one woven fabric of continuous filament yarns.

Fabric structure 17 is a nonwoven fabric comprising a blend of discontinuous fibers of oxidized polyacrylonitrile fibers and silica fibers. In some embodiments, the oxidized polyacrylonitrile fibers are present in an amount of from about 30 to about 70 weight percent of the combined weight of the oxidized polyacrylonitrile fibers and silica fibers, and in other embodiments of from about 40 to about 60 weight percent of the combined weight of the oxidized polyacrylonitrile fibers and silica fibers. In some embodiments, the nonwoven fabric has an areal weight of from about 100 to about 170 gsm, in other embodiments of from about 100 to about 240 gsm, and in other embodiments of from about 100 to about 305 gsm. Preferably, the fabric structure 17 comprises only one nonwoven fabric but more than one nonwoven fabric may be incorporated into the fabric structure 17.

The fabric structure 16 of textile component 12 may be attached to fabric structure 17 by an attachment means. Suitable attachment means for attaching the fabric structures 16 and 17 together include, but are not limited to, adhesion, stitching, or fiber entanglement.

Adhesion may be obtained by placing an adhesive, preferably an adhesive film, between fabric structures 16 and 17 and curing the adhesive or by impregnating one or both fabric structures 16 and 17 with a matrix resin, placing fabric structure 16 in contact with fabric structure 17 and curing the matrix resin.

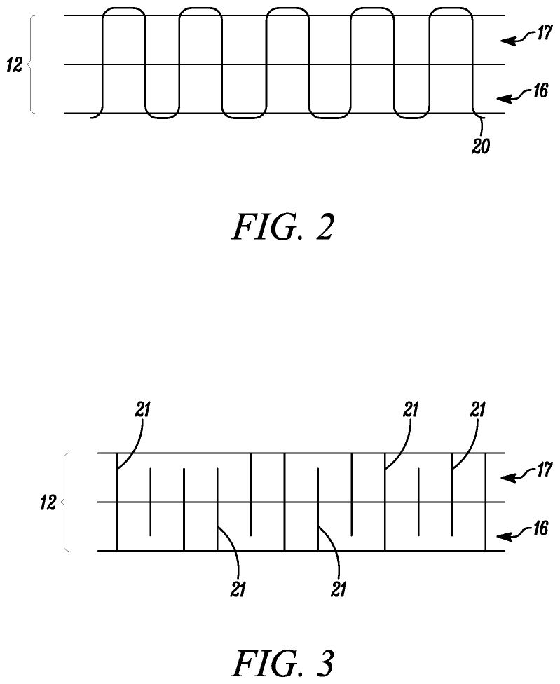

FIG. 2 shows a sectional view example of the stitching option where stitches 20 pass through the two fabric structures 16 and 17 of the textile component 12.

FIG. 3 shows a sectional view example of the fiber entanglement option. This is often referred to as needlepunching or needling. In this process, fine needle barbs repeatedly penetrate through the textile component 12 causing filaments to reorientate and extend in the z-direction approximately perpendicular to the x-y plane of the textile component 12. This intermingling of the filaments 21 among the two fabric structures 16 and 17 improves flammability resistance of the textile component.

In some embodiments, some combination of adhesion, stitching, or fiber entanglement may be used as attachment means.

Textile component 12 should preferably have an inter-fabric bond strength when subject to puncture of at least 11 kg/10 cm when tested according to ASTM D1876-08(2015)—Standard Test Method for Peel Resistance of Adhesives, i.e., there is no delamination between fabric structure 16 and fabric structure 17 until a pull strength of at least 11 kg/10 cm has been achieved.

In some embodiments, one or more of the fabric structures 16 and 17 of textile component 12 are impregnated with a matrix resin such that the resin is present in an amount of from about 5 to about 45 weight percent of the combined weight of resin and fiber in each of the one or more impregnated fabric structures, in other embodiments of from about 7 to about 40 weight percent of the combined weight of resin and fiber in each of the one or more impregnated fabric structures, in other embodiments of from about 7 to about 20 weight percent of the combined weight of the resin and fiber in each of the one or more impregnated fabric structures, and in other embodiments of from about 15 to about 20 weight percent of the combined weight of the resin and fiber in each of the one or more impregnated fabric structures. The matrix resin may be phenolic, flame-retarded epoxy or flame retarded polyurethane. Bio-based resins may also be used such as bio-based perfluoroalkoxy copolymer, bio-based epoxy vitrimer, bio-based polyetherimide, lignin bio-based phenolic, bio-based polycarbonate, soybean based unsaturated polyester, bio-based benzoxazine, bio based epoxy resin and green polyethylene. The resin is cured as per the recommended cure cycle from the supplier. A continuous belt press is one example of equipment in which the curing process may be affected.

In one preferred embodiment both fabrics 16 and 17 are impregnated with a matrix resin. In yet another embodiment, both fabric structures 16 and 17 are attached to each other by an attachment means as well as being impregnated with a matrix resin.

Embodiments in which at least one fabric structure 16 or 17 of textile component 12 is impregnated with resin provides a composite sheet 11 that is rigid and that has a limited capability of being rolled up. Embodiments in which the textile component 12 is not impregnated with resin provides a composite sheet 11 that is semi-rigid i.e., flexible and capable of being rolled up.

### Woven Fabric

Suitable weave styles for the one or more woven fabrics of fabric structure 16 include plain weave, satin weave, basket weave, leno weave or twill weave. One suitable fabric for the one or more woven fabrics of fabric structure 16 is a scoured 230 gsm 17×17 pick count plain weave fabric made from 1500 denier Kevlar® 29 p-aramid yarn. Alternatively, the one or more woven fabrics of fabric structure 16 may be a plain weave fabric comprising 555 dtex (500 denier) KM2+p-aramid yarns in an amount of 11 ends per cm (28 ends per inch) in both warp and weft directions. Where there is more than one woven fabric in fabric structure 16, these woven fabrics may be the same or different either in yarn composition and/or weave style. In some embodiments, the one or more woven fabrics of fabric structure 16 have an areal weight of from about 70 to about 508 gsm (2.1 to 15 oz. per sq. yd.), in other embodiments of from about 101 to about 373 gsm (3 to 11 oz. per sq. yd.), and in other embodiments from about 101 to about 170 gsm (3 to 5 oz. per sq. yd.).

In some embodiments, the one or more woven fabrics of fabric structure 16 are scoured or heat cleaned after weaving. Such processes are well known in the textile industry to remove contaminants such as oil from the weaving process.

The one or more woven fabrics of fabric structure 16 are made from multifilament yarns having a plurality of filaments. The yarns can be intertwined and/or twisted. For purposes herein, the term “filament” is defined as a relatively flexible, macroscopically homogeneous body having a high ratio of length to width across its cross-sectional area perpendicular to its length. The filament cross section can be any shape but is typically circular or bean shaped. Herein, the term “fiber” is used interchangeably with the term “filament”, and, when relating to pick count, the term “end” is used interchangeably with the term “yarn.”

The filaments can be any length. Preferably the filaments are continuous. Multifilament yarn spun onto a bobbin in a package contains a plurality of continuous filaments. The multifilament yarn can be cut into staple fibers and made into a spun staple yarn suitable for use in the one or more woven fabrics of fabric structure 16. The staple fiber can have a length of about 1.5 to about 5 inches (about 3.8 cm to about 12.7 cm). The staple fiber can be straight (i.e., non-crimped) or crimped to have a saw tooth shaped crimp along its length, with a crimp (or repeating bend) frequency of about 3.5 to about 18 crimps per inch (about 1.4 to about 7.1 crimps per cm).

In some embodiments, the yarns of the one or more woven fabrics of fabric structure 16 have a yarn tenacity of at least about 11 grams per dtex and a modulus of at least about 100 grams per dtex. In some embodiments, the yarns of the one or more woven fabrics of fabric structure 16 have a linear density of from about 333 to about 2222 dtex (300 to 2000 denier), in other embodiments of from about 555 to about 1111 dtex (500 to 1000 denier), in other embodiments of about 555 dtex, and in other embodiments of about 1111 dtex.

The fibers of the yarns of fabric structure 16 may be polymeric, inorganic or natural and may be made from any suitable material known in the art. In some embodiments, the fibers of the yarns may be aromatic polyamide, aromatic copolyamide, aliphatic polyamide, polyolefins, polyazoles, glass, carbon, multi-component fibers, and combinations thereof.

When the polymer is polyamide, aramid is preferred. As used herein, “aramid” is meant a polyamide polymer wherein at least 85% of the amide (—CONH—) linkages are attached directly to two aromatic rings. Para-aramid polymers are aramid polymers where the amide linkages are in the para-position relative to each other. One preferred para-aramid polymer is poly (paraphenylene terephthalamide) or PPD-T. Additives can be used with the aramid and, in fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. Suitable aramid fibers are described in Man-Made Fibres—Science and Technology, Volume 2, Section titled Fibre-Forming Aromatic Polyam ides, page 297, W. Black et al., Interscience Publishers, 1968. Aramid fibers and their production are, also, disclosed in U.S. Pat. Nos. 3,767,756; 4,172,938; 3,869,429; 3,869,430; 3,819,587; 3,673,143; 3,354,127; and 3,094,511.

Other useful para-aramids include aramid copolymers resulting from the incorporation and/or substitution of other aromatic diamines and other aromatic diacid chlorides such as, for example, 2,6-naphthaloyl chloride or chloro- or dichloroterephthaloyl chloride or 3,4′-diaminodiphenylether. Another preferred para-aramid comprises aramid copolymers derived from 5(6)-amino-2-(p-aminophenyl) benzimidazole (DAPBI), para-phenylenediamine (PPD), and terephthaloyl dichloride (TCI or T, also commonly referred to as terephthaloyl chloride); such as, for example in U.S. Pat. Publ. No. 2014/0357834, Russian Patent Application No. 2,045,586 and other such fibers provided in, for example, Sugak et al., Fibre Chemistry Vol 31, No 1, 1999; U.S. Pat. No. 4,018,735; and WO 2008/061668, and US 2014/357834-A1.

Examples of para-aramid fibers that are commercially available include Kevlar® from DuPont in Wilmington, Delaware, and Twaron® from Teijin Aramid in Arnhem, Netherlands. Examples of aramid copolymer fibers include Armos® and Rusar® from Kamenskvolokno Company in Kamensk-Shakhtinskii, Russia.

Glass fibers may include “E” glass and “S” Glass. E-Glass is a commercially available low alkali glass. One typical composition consists of 54 weight % SiO₂, 14 weight % Al₂O₃, 22 weight % CaO/MgO, 10 weight % B₂O₃ and less than 2 weight % Na₂O/K₂O. Some other materials may also be present at impurity levels. S-Glass is a commercially available magnesia-alumina-silicate glass. This composition is stiffer and stronger than E-glass and is commonly used in polymer matrix composites. Exemplary woven fabrics for fabric structure 16 include, but are not limited to, heat cleaned weave styles 7781 with E-glass yarn and 6781 with S-glass yarn.

A suitable carbon fiber is a standard or intermediate modulus fiber such as those available under the tradename Torayca from Toray Industries or HexTow from Hexcel Corporation. Typically, such fibers have 3,000 or 6,000 or 12,000 or 24,000 filaments per tow.

In some embodiments, fabric structure 16 may optionally be treated with a fire-retardant ingredient. Suitable fire-retardant ingredients include, but are not limited to, antimony trioxide, halogenated flame retardants including tetrabromobisphenol A, polybrominated biphenyls, pentabrominateddiphenylether(oxide), octabrominateddiphenylether(oxide), decabrominateddiphenylyether(oxide) and hexabromocyclododecane. Phosphorus containing fire retardants are also widely used.

### Polymeric Coatings

The polymer of first polymeric coating 15 or second polymeric coating 19 may be a thermoplastic polymer or thermoset polymer or silicone rubber.

Suitable polymers include polyurethane, polyethylene, polypropylene, polyethylenenaphthalate, polyacrylonitrile, fluoropolymer, polyimide, polyketone, polyimide (Kapton®), polysulfone, polyarlenesulfide, liquid crystal polymer, polycarbonate, and ionomers such as ethylenemethacrylicacid copolymer (E/MAA).

Exemplary fluoropolymers include polyvinylfluoride (Tedlar®), ethylenechlorotrifluoroethylene copolymer (Halar®) and polytetrafluroethylene (Teflon®). Exemplary polyketones include polyetheretherketone (PEEK) and polyetherketoneketone (PEKK).

In one embodiment, first polymeric coating 15 is polyurethane. In another embodiment, second polymeric coating 19 is an ionomeric resin such as ethylenemethacrylicacid copolymer. In yet another embodiment, first polymeric coating 15 is non-transparent and impervious to UV rays. By non-transparent and impervious to UV rays we mean that at least 95% of UV rays, more preferably at least 98% and most preferably 100% of UV rays are blocked especially those rays at the upper end of the UV spectrum.

In some embodiments, first polymeric coating 15 and/or second polymeric coating 19 have an areal weight of about 17 to about 170 gsm (0.5 to 5 oz. per sq. yd.), in other embodiments from about 34 to about 136 gsm (1 to 4 oz. per sq. yd.), and in other embodiments from about 67 to about 102 gsm (2 to 3 oz. per sq. yd.).

Preferably, first and second polymeric coatings 15 and 19 respectively may be polyurethane, silicone rubber, polyvinylchloride or blends thereof. In some embodiments, second polymeric coating 19 may be an ionomeric resin based on ethylene acid copolymer such as Surlyn®.

First polymeric coating 15 contacts the first surface 13 of the textile component 12 and provides chemical and environmental (i.e. weather and UV) resistance to both physical and chemical attack and permeation by liquids.

By chemical and environmental/weather resistant is meant that the ability of the polymeric coating to withstand, without excessive degradation, the effects of wind, rain, contaminants such as acidic and/or oily residues found in typical industrial areas, and sun exposure. Preferably, first polymeric coating 15 has an enhanced ability to resist damage by chemical reactivity or solvent action from hydrocarbons, chemicals, ozone, bacteria, fungus, and moisture, as well as skin oils typically associated with operation and maintenance of a commercial aircraft.

By UV resistant is meant that, when exposed to ultraviolet radiation, first polymeric coating 15 retains its appearance and physical integrity without an excessive degradation of its flexibility or mechanical properties (i.e. brittleness). Preferably, the polymeric layer blocks at least 95% of UV rays, more preferably at least 98% and most preferably 100% of UV rays. UV imperviousness of the polymeric coating 15 can be further mitigated by inclusion of additives in the polymeric material. Examples of such additives include fillers, colors, stabilizers, and lubricants. The outer surface of first polymeric coating 15 that is not in contact with the fabric structure 16 may optionally be coated or treated with a UV blocking material.

Ultraviolet (UV) is an invisible band of radiation at the upper end of the visible light spectrum. At wavelengths ranging from 10 to 400 nm, ultraviolet (UV) starts at the end of visible light and ends at the beginning of X-rays. As the primary exposure of the composite sheet 11 to ultraviolet light is the sun, the most critical UV resistance is that to the lower-frequency, longer-wavelength rays.

Preferably, first polymeric coating 15 has a soft, non-plastic feel that is ideal for products that come in contact with the human skin and maintains its toughness and flexibility over a wide temperature range, even at temperatures as low as −50° C. (−60° F.), over the life span of the product.

In some embodiments, the outer surface of first polymeric coating 15, i.e., the surface that is not in contact with fabric structure 16, has a release value of no more than 263 N/m (1.5 lb./in), more preferably no more than 438 N/m (2.5 lb./in) when measured according to ASTM D2724-07(2011)e1 Standard Test Methods for Bonded, Fused, and Laminated Apparel Fabrics. This facilitates cleaning, label removal etc.

In some embodiments, fabric structure 16 may be bonded to first polymeric coating 15 by means such as an adhesive, thermal bonding or by fasteners. This adhesive may be a thermoplastic or thermoset resin. Thermoset resins include, but are not limited to, epoxy, epoxy novolac, phenolic, polyurethane, and polyimide. Thermoplastic resins include, but are not limited to, polyester, polyetherketone, polyetheretherketone, polyetherketoneketone, polyethersulfone and polyolefin. Thermoplastic resins are preferred.

Preferably, the adhesive may optionally contain up to about 40 weight percent of a flame retardant ingredient. Suitable flame retardant ingredients include, but are not limited to, antimony trioxide, halogenated flame retardants including tetrabromobisphenol A, polybrominated biphenyls, pentabrominateddiphenylether(oxide), octabrominateddiphenylether(oxide), decabrominateddiphenylyether(oxide) and hexabromocyclododecane. Phosphorus containing flame retardants are also widely used.

Preferably, the adhesive blocks at least about 95% of UV rays, more preferably at least about 98% and most preferably about 100% of UV rays. The adhesive may further comprise fillers, colors, stabilizers, and other performance enhancing additives.

Preferably, the adhesive bond between first polymeric coating 15 and fabric structure 16 is at least about 263 N/m (1.5 lb./in). In some embodiments, the adhesive bond between first polymeric coating 15 and fabric structure 16 is at least about 438 N/m (2.5 lb./in), and in other embodiments about 876 N/m (5 lb./in).

Second polymeric coating 19 which is the innermost layer of the composite sheet 11 contacts the second surface 14 of the textile component 12. This second polymeric coating 19 may also be pigmented and contain ultra-violet (UV) blocking agents. An acceptable UV resistance is the ability to withstand exposure to strong direct sunlight for 10 years without compromising basic mechanical and visual properties of the sheet. A suitable standard is ASTM G154-16 (UVA-340 Lamps, 16 hours of UV at 60±2° C. and 8 hours condensation at 50±2° C. over a time period of 240 hours.

In some embodiments, fabric structure 17 may be bonded to second polymeric coating 19 by a suitable bonding means such as an adhesive, thermal bonding, or by fasteners. Adhesives similar to those described above for bonding fabric structure 16 to first polymeric coating 15 may be utilized here.

A typical coating for either the first or second polymeric coatings 15 and 19 has a thickness of about 75 micrometers and an areal weight of about 90 gsm. The coating should have a vertical flame flammability rating meeting UL 94V-0 and be able to withstand exposure from −40 to +60 degrees C. without compromising basic mechanical and visual properties such as flexibility, color, transparency etc.

### Utility

The composite sheet 11 described herein has useful fire-resistant properties and is suitable as a curtain wall material in a cargo container, particularly containers used in aircraft. Aircraft cargo containers are frequently called unitary load devices (ULDs). In a preferred embodiment, when assembled into the container frame, the composite sheet 11 is positioned so that structure 17 of the textile component 12 is positioned to face a fire threat from the cargo. The fire threat direction is shown by an arrow in FIG. 1. The composite sheet 11 is compliant with the test methods described below.

The term “innermost” as used in this disclosure refers to that part of composite sheet 11 which, when the composite sheet is assembled into a cargo container, is facing the cargo. The term “outermost” as used in this disclosure refers to that part of composite sheet 11 which, when the composite sheet is assembled into a cargo container, is furthest away from the cargo.

The composite sheet 11 would also be able to provide useful fire-resistant properties when it is exposed to a fire external to the cargo container where first structure 16 would be facing the flame.

### Test Methods

Flame penetration was measured according to 14 CFR 25.855 Appendix F Part III—Test Method to Determine Flame Penetration Resistance of Cargo Compartment Liner (ceiling position). This is referenced in the examples as “Test Method 1”.

The composite sheet was subjected to a flame test that replicated the temperature and air mass flux test conditions of test method FAA FAR 25.856(b), App. F, Part VII. The somewhat lower heat flux was compensated with a higher air mass flux to replicate a required thermo-mechanical stress level to be exerted on the flame barrier composite sheet during the burn-through test. This is referenced in the examples as “Test Method 2.

A wash-dry cycle consisted of a 4 lb. load with each warm water wash cycle having a duration of 40 minutes. The detergent was 66 g of 1993AATCC Standard Reference Detergent. Each drying cycle lasted 40 minutes, the drying medium being forced cold air.

### EXAMPLES

The following examples are given to illustrate exemplary embodiments of the invention and should not be interpreted as limiting it in any way. All parts and percentages are by weight unless otherwise indicated. Examples prepared according to the process or processes described herein are indicated by numerical values. Control or Comparative Examples are indicated by letters.

### Example 1

The textile component 12 was assembled as in FIG. 1. Fabric structure 16 of the textile component 12 was a 230 gsm plain weave Kevlar® fabric woven from 1500 denier yarn having a pick count of 17 yarns per inch in both warp and weft. The fabric structure 17 of the textile component 12 was a nonwoven fabric from Tex Tech Industries, North Monmouth, ME. This nonwoven fabric had a nominal weight of 239 gsm and comprised 50 weight percent of pre-oxidized polyacrylonitrile fibers type ZOLTEK™ OX and 50 weight percent of Beloctex™ silica fibers.

The two fabric structures 16 and 17 were mechanically attached to each other by needepunching. There was no first or second polymeric coatings 15 and 19 in this example.

Two samples of the textile component 12 were subjected to the wash-dry cycles and two samples were not subjected to wash dry cycles so as to function as controls.

Two additional samples of the textile component 12 were impregnated with GP® 445D05 RESI-SET® phenolic resin such that the resin content was nominally 28.0 weight percent of the combined weight of polyacrylonitrile fiber, silica fiber, and resin. The resin was then cured to give a rigid textile component 12.

All six sample specimens of Example 1 were subjected to, and passed, Test Method 2. In this test, the fabric structure 17 was facing the flame.

It was also observed that the test specimens subjected to the wash-dry cycles had less smoke and off-gassing during the flame test than unwashed test specimens.

A further observation between the six specimens of Example 1 is that, after flame exposure, the resin impregnated specimens had noticeably better residual cohesive integrity than the non-impregnated specimens, with washed specimens showing the lower post-flame exposure residual cohesive integrity than unwashed specimens.

### Example 2

This example was prepared as Example 1 except that fabric structure 17 had an areal weight of 307 gsm. The two fabrics 16 and 17 were mechanically attached to each other by needlepunching.

Test samples were prepared as in Example 1. All six samples were subjected to, and passed, Test Method 2. In this test, fabric structure 17 was facing the flame.

There was no noticeable performance difference between corresponding washed, unwashed and resin impregnated specimens of Examples 1 and 2, nor there was any obvious difference in appearance or level of physical degradation between corresponding specimens of those two samples during and after flame exposure.

### Example 3

The textile component 12 was as in Example 1. The two fabrics 16 and 17 were mechanically attached to each other by needepunching. The textile component 12 was not impregnated with resin and thus gave a flexible textile component 12.

A non-transparent 0.075 mm (3 mil) cast polyurethane film was thermally bonded to both the first surface 13 and the second surface 14 of an unwashed specimen of the textile component 12 thus providing first polymeric coating 15 and second polymeric coating 19 respectively.

The example was subjected to, and passed, Test Method 2. In this test, second polymeric coating 19 was exposed to the flame with fabric structure 17 being next to second polymeric coating 19.

### Example 4

The textile component 12 was as in Example 1. The two fabrics 16 and 17 were mechanically attached to each other by needepunching. Textile component 12 was impregnated with GP® 445D05 RESI-SET® phenolic resin such that the resin content was nominally 28.0 weight percent of the combined weight of polyacrylonitrile fiber, silica fiber and resin. The resin was then cured to give a rigid textile component.

A non-transparent 0.075 mm (3 mil) cast polyurethane film was thermally bonded to both the first surface 13 and the second surface 14 of textile component 12 thus providing first polymeric coating 15 and second polymeric coating 19 respectively.

The example was subjected to, and passed, Test Method 2. In this test, the second polymeric coating 19 was exposed to the flame with fabric structure 17 being next to second polymeric coating 19.

### Comparative Example A

The textile component 12 of this Example comprised a plain weave p-aramid fabric woven from 1500 denier Kevlar® K29 yarn, the fabric having 26 ends per inch in both warp and weft and a 190 gsm plain weave E-glass fabric (ECG). The two fabrics were not mechanically entangled by needlepunching nor was the textile component impregnated with resin. There was no first or second polymeric coatings 15 or 19 in this example. This example failed Test Method 1 thus demonstrating the benefit provided by second structure 17 as previously described in delivering enhanced flame resistance properties.

### Comparative Example B

This Example was prepared as in Example 1 except that second structure 17 was omitted. There was first or second no polymeric coatings 15 or 19 in this example. The unwashed structure failed both Test Methods 1 and 2 thus demonstrating the benefit provided by second structure 17 in delivering enhanced flame resistance properties.

### Comparative Example C

The textile component 12 of this example was assembled as in FIG. 1. The fabric structure 16 was a plain weave p-aramid fabric woven from 1500 denier Kevlar® K29 yarn. This aramid fabric had 26 ends per inch in both warp and weft. The fabric structure 17 of textile component 12 was a nonwoven fabric from Tex Tech Industries. This nonwoven fabric had a nominal weight of 170 gsm and comprised 50 weight percent of pre-oxidized polyacrylonitrile fibers type ZOLTEK™ OX and 50 weight percent of Beloctex™ silica fibers. The textile component 12 was needlepunched but not impregnated with resin. There was no first or second polymeric coatings 15 or 19 in this example. Further, the samples were not washed. Although performing well for the first two minutes of the flame tests, with fabric structure 17 facing the flame, the performance in the remaining three minutes was less than desirable and therefore the example was considered as having failed Test Method 2 and Test Method 1. This was attributable to the lower areal weight of second structure 17. Although failing Test Methods 1 and 2, a composite sheet of this example may be suitable for less demanding fire-resistance applications.

1. A composite sheet comprising a textile component having a first and a second surface and a first polymeric coating on the first surface of the textile component wherein the textile component further comprises
a first fabric structure of at least one woven fabric of continuous filament yarns, the woven fabric having an areal weight of from about 70 to about 508 gsm, and
a second fabric structure of a nonwoven fabric comprising a blend of discontinuous fibers of oxidized polyacrylonitrile fibers and silica fibers, wherein the oxidized polyacrylonitrile fibers are present in an amount of from about 30 to about 70 weight percent of the combined weight of the oxidized polyacrylonitrile fibers and silica fibers.

2. The composite sheet of claim 1, further comprising a second polymeric coating on the second surface of the textile component.

3. The composite sheet of claim 1, wherein the filaments of the at least one woven fabric of the first fabric structure are of aromatic polyamide, aromatic copolyamide, glass, carbon, or aliphatic polyamide.

4. The composite sheet of claim 1, wherein at least one of the first fabric structure and the second fabric structure is impregnated with a matrix resin.

5. The composite sheet of claim 1, wherein the first polymeric coating on the first surface of the textile component is polyurethane, silicone rubber, polyvinylchloride, or a blend thereof.

6. The composite sheet of claim 1, wherein the first structure and the second structure are attached to each other by an attachment means.

7. The composite sheet of claim 1, wherein the at least one woven fabric of the first fabric structure has an areal weight of at least 203 gsm.

8. The composite sheet of claim 2, wherein the second polymeric coating on the second surface of the textile component is polyurethane, silicone rubber, polyvinylchloride, ethylene acid copolymer, or blends thereof.

9. The composite sheet of claim 3, wherein the aromatic polyamide filaments of the at least one woven fabric of the first fabric structure are p-aramid.

10. The composite sheet of claim 4, wherein the matrix resin is phenolic, flame-retarded epoxy, flame retarded polyurethane, or bio-based.

11. The composite sheet of claim 4, wherein the resin is present in an amount of from about 5 to about 45 weight percent of the combined weight of resin and fiber in the at least one of the first fabric structure and the second fabric structure.

12. The composite sheet of claim 6, wherein the attachment means is adhesion, stitching, or fiber entanglement.

13. The composite sheet of claim 7, wherein the nonwoven fabric of the second fabric structure has an areal weight of at least 237 gsm.

14. A cargo container comprising the composite sheet of claim 1.
